(19) United States
(12) Patent Application Publication
(10) Pub. No.: US 2008/0171169 A1
(43) Pub. Date: Jul. 17, 2008

(54) Oxygen Scavenging Compositions and Method of Preparation

(75) Inventor: Zhenguo Liu, Greer, SC (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: INVISTA North America S.a.r.l., Wilmington, DE (US)

(21) Appl. No.: 11/911,288

(22) PCT Filed: Apr. 7, 2006
(86) PCT No.: PCT/US06/13065

§ 371 Date: Oct. 11, 2007

Related U.S. Application Data
(60) Provisional application No. 60/670,789, filed on Apr. 13, 2005.

(51) Int. Cl. B32B 1/02; C08G 63/66; C08G 63/52; C09K 3/00; C08F 120/00

(52) U.S. Cl. 428/36.92; 528/303; 528/301; 528/300; 526/318.1; 252/188.28; 428/35.7

(57) ABSTRACT

The object of the invention is to provide a polyester composition that actively scavenges oxygen, with or without a transition metal catalyst. This was achieved by using a monomer selected from the group consisting of linear difunctional monomers having the general formula: X—(CH₂)ₙ—CH═CH—(CH₂)ₘ—X′ wherein X and X′ are each independently selected from the group consisting of OR and COOR, wherein R is selected from the group consisting of H and alkyl groups with one or more carbon atoms; and n and m are each independently 1 or more. The preferred monomer is 2-butene-1,4-diol (BEDO), and the preferred polyester is the reaction product of this diol with terephthalic acid to form poly(oxy-2-butene-1,4-diyloxycarbonyl-1,4-phenylenecarbonyl)—PBET. Copolymers of PBET are also within the scope of this invention. The polyester oxygen scavenging composition is then blended with conventional container resin such as polyesters, polyamides or polyolefins to make a container.

### RELATED APPLICATION

The benefit of the priority of U.S. Provisional Application Ser. No. 60/670789 filed Apr. 13, 2005 is claimed.

### BACKGROUND INFORMATION

1. Field of Invention

This invention relates to an organic polymeric composition that is an active oxygen gas barrier. The present invention also relates to an improved oxygen scavenging system which can be employed in films, sheets, and molded or thermoformed shapes such as containers that find utility in low oxygen barrier packaging for pharmaceuticals, cosmetics, oxygen sensitive chemicals, electronic devices, and in particular food and beverage packaging. In particular the composition is based on polyesters prepared from diols containing allylic hydrogen atoms, such as 2-butene 1-4diol. Moreover, this invention also relates to a method of preparing polyester articles from diols containing allylic hydrogen atoms, such as 2-butene 1-4diol.

2. Prior Art

Plastic materials have been replacing glass and metal packaging materials due to their lighter weight, decreased breakage compared to glass, and potentially lower cost. One major deficiency with polyesters is its relatively high gas permeability. This restricts the shelf life of carbonated soft drinks and oxygen sensitive materials such as beer and fruit juices. Organic oxygen scavenging materials have been developed partly in response to the food industry's goal of having longer shelf-life for packaged food.

One method which is currently being employed involves the use of “active packaging” where the package is modified in some way so as to control the exposure of the product to oxygen. Such “active packaging” can include sachets containing iron based compositions which scavenges oxygen within the package through an oxidation reaction.

Other techniques involve incorporating an oxygen scavenger into the package structure itself. In such an arrangement, oxygen scavenging materials constitute at least a portion of the package, and these materials remove oxygen from the enclosed package volume which surrounds the product or which may leak into the package, thereby inhibiting spoilage and prolonging freshness in the case of food products.

Oxygen scavenging materials in this environment include low molecular-weight oligomers that are typically incorporated into polymers or can be oxidizable organic polymers in which either the backbone or, initially at least, side-chains of the polymer react with oxygen.

Such oxygen scavenging materials are typically employed with a suitable catalyst, e.g., an organic or inorganic salt of a transition metal catalyst such as cobalt. Examples of other suitable catalysts are organic and inorganic salts of iron, manganese, copper, and molybdenum.

Multilayer bottles containing a low gas permeable polymer as an inner layer, with polyesters as the other layers have been commercialized. The use of multilayer bottles that contain core layers of an oxygen scavenging material is commonplace. Typically, the center layer is a blend of inorganic or organic polymeric, oxygen scavenging material. Multilayer oxygen scavenging packages and walls for a package are disclosed in U.S. Pat. Nos. 5,021,515; 5,639,815; and 5,955,527 to Cochran. The multilayer packages of Cochran comprise inner and outer layers of a non-oxidizable polymer and a core layer that consists of an oxidizable polymer and a catalyst, or polymer blends containing an oxidizable polymer and a catalyst. The oxidizable polymer is a polyamide such as MXD-6 nylon.

Blends of poly(ethylene terephthalate) (PET) and MXD-6 in multilayer applications are also disclosed in U.S. Pat. No. 5,077,111 to Collette. Collette discloses a five layer preform wherein the inner, outer and core layer are formed of PET, and the inner and outer intermediate layers are formed from a blend of PET and MXD-6. Similar to the bottles disclosed in Cochran, the oxidizable polymer MXD-6, comprises the core layer and is encapsulated by PET in the multilayer container of Collette.

WO2005/023530 to Mehta et al. discloses the use of an ionic compatibilizer to reduce the haze of monolayer containers prepared from a blend of PET and MXD-6.

U.S. Pat. No. 5,736,616 to Ching et al. discloses oxygen scavenging compositions comprising a transition metal salt and a compound having an ethylenic or polyethylenic backbone, and a pendant or terminal moiety containing a benzylic, allylic or ether containing radical. These compositions are compatible with polyolefins, but not polyesters.

U.S. Pat. Application 2003/0157283 to Tai et al discloses a blend of an oxygen absorptive resin having double bonds, preferably an aromatic vinyl compound and a diene, with a gas barrier resin such as ethylene vinyl alcohol copolymer.

U.S. Pat. No. 4,031,065 to Cordes et al. discloses the use of 0.1 to 10 mole % of an aliphatic diol, or an aliphatic dicarboxylic acid, containing at least one olefinic double bond, to crosslink polyesters to raise their melt viscosity. The presence of compounds which dissociates at elevated temperatures to give free radicals is a preferred embodiment. Such cross-linked copolyesters are suitable for the manufacture of heavy-duty injection moldings. There is no teaching with regard to oxygen scavenging.

U.S. Pat. No. 6,455,620 to Cyr et al. discloses polyethers, such as poly(alkylene glycols), as oxygen scavenging moieties blended with thermoplastic polymers and a transition metal catalyst. There is no teaching with regard to the performance and haze of these compositions in stretch blow molded containers.

U.S. Pat. No. 6,863,988 and U.S. Pat. Application No. 2005/0170115 to Tibbitt et al. disclose monolayer packages comprised of an oxygen scavenging composition having a modified copolymer of predominantly polyester segments and an oxygen scavenging amount of oxygen scavenging segments, such as polybutadiene. At the levels of the oxygen scavenging segments required for the shelf life of a package, the package has an unacceptable level of haze.

There is a need for an oxygen scavenging composition that can be used as a layer in a multilayer packaging article, or as a blend in monolayer packaging articles, that is compatible with polyester such that these articles have a low haze level.

### SUMMARY OF THE INVENTION

The object of the invention is to provide a polyester composition that actively scavenges oxygen, with or without a transition metal catalyst. This was achieved by using a monomer selected from the group consisting of linear difunctional monomers having the general formula:

X—(CH₂)ₙ—CH═CH—(CH₂)ₘ—X′

wherein X and X′ are each independently selected from the group consisting of OR and COOR, wherein R is selected from the group consisting of H and alkyl groups with one or more carbon atoms; and n and m are each independently 1 or more. The preferred monomer is 2-butene-1,4-diol (BEDO), and the preferred polyester is the reaction product of this diol with terephthalic acid to form poly(oxy-2-butene-1,4-diyloxycarbonyl-1,4-phenylenecarbonyl)—PBET. Copolymers of PBET are also within the scope of this invention.

Another objective is a method of preparing articles from PBET or its copolymers, either in their pure form or blended with thermoplastic polymers such as poly(ethylene terephthalate)—PET and PET copolymers. PBET and its copolymers, including blends with other polyesters, can be formed into a film, a sheet that is thermoformed into a container, or a preform that is stretch blow molded into a low haze container.

In the broadest sense, the present invention relates to a polyester resin composition, comprising polyesters or copolyesters containing allylic hydrogen atoms, prepared by using diols such as 2-butene-1,4-diol.

In the broadest sense, the present invention relates to a container resin and an article made therefrom, comprising polyesters, polyamides and polyolefins, containing allylic hydrogen atoms, prepared by using diols such as 2-butene-1,4-diol.

In the broadest sense, the present invention relates to a method of blending a base resin with a polyester oxygen scavenging resin composition, comprising polyesters or copolyesters containing allylic hydrogen atoms, prepared by using diols such as 2-butene-1,4-diol.

### DESCRIPTION OF THE PREFERRED EMBODIMENTS

In the present invention, a thermoplastic polyester containing allylic hydrogen atoms as a component of the diol is used. The polyester containing allylic hydrogen atoms can be a homopolymer or a copolymer with other monomers. In addition this unsaturated polyester can be blended with saturated polyesters for processing into articles.

According to the invention one or more monomers are selected from the group consisting of linear difunctional monomers having the general formula:

X—(CH₂)ₙ—CH═CH—(CH₂)ₘ—X′

wherein X and X′ are each independently selected from the group consisting of OR and COOR, wherein R is selected from the group consisting of H and alkyl groups with one or more carbon atoms; and n and m are each independently 1 or more. The preferred monomer is 2-butene-1,4-diol (BEDO), and the preferred polyester is the reaction product of this diol with terephthalic acid (or its ester equivalent, such as dimethyl terephthalate) to form poly(oxy-2-butene-1,4-diyloxycarbonyl-1,4-phenylenecarbonyl)—PBET.

Generally polyesters, both saturated and unsaturated can be prepared by one of two processes, namely: (1) the ester process and (2) the acid process. The ester process is where a dicarboxylic ester is reacted with the diol in an ester interchange reaction. Because the reaction is reversible, it is generally necessary to remove the alcohol (methanol when the dimethyl ester is employed) to completely convert the raw materials into monomers. Certain catalysts are well known for use in the ester interchange reaction. Conventionally, catalytic activity was sequestered by introducing a phosphorus compound, for example polyphosphoric acid, at the end of the ester interchange reaction. Primarily the ester interchange catalyst was sequestered to prevent yellowness from occurring in the polymer.

Then the monomer undergoes polycondensation and the catalyst employed in this reaction is generally an antimony, germanium or titanium compound, or a mixture of these.

In the second method for making polyester, a dicarboxylic acid is reacted with a diol by a direct esterification reaction producing monomer and water. This reaction is also reversible like the ester process and thus to drive the reaction to completion one must remove the water. The direct esterification step does not require a catalyst. The monomer then undergoes polycondensation to form polyester just as in the ester process, and the catalyst and conditions employed are generally the same as those for the ester process. The polyester after polycondensation to the require molecular weight is extruded into strands, quenched and cut into pellets. The molecular weight is generally chosen to give an economical balance of good color (low yellowness) and to minimize to amount of solid state polymerization required for certain end uses.

For container applications that require a low level of acetaldehyde, these pellets are further polymerized to a higher molecular weight by conventional, well known solid state processes.

To prepare the compositions of this invention, typically dimethyl terephthalate (DMT) or terephthalic acid (TA) is esterified with BEDO with an alkyl titanate catalyst at 170° to 200° C. for 45-60 minutes followed by polycondensation at about 200° to 230° C. for about 120 minutes under vacuum. Care must be taking to polymerize at temperatures of about 230° C. or less in order to prevent cross-linking of the polymer. Solid state polymerization is conducted at about 130° to 150° C. for 24 to 30 hours.

Copolyesters of PBET can be prepared by: replacing part of (up to 75 mol % based on the diol moles) the BEDO with other diols such as 1,4-butane-diol (BDO), neopentyl glycol, 2-methyl-1,3-propanediol, or cyclohexanedimethanol; or replacing part of the BEDO with poly(alkylene oxide) glycol (PAOG); or replacing part of (up to 50 mol % based on the diacid moles) the DMT/TA with the dimethyl ester of isophthalic acid, naphthoic acid, or aliphatic acids such as adipic acid, alternatively the acid form of the dimethyl esters (i.e., isophthalic acid, naphthoic acid, or aliphatic acids such as adipic acid) may be used, or the anhydride of the acid may be used. Of course, the scope of the invention comprises replacing both some of the BEDO and some of the DMT/TA with these comonomers. Preferred copolyesters of PBET are those where a portion of the BEDO is replaced with BDO (PBET/BDO) and/or a poly(alkylene oxide) glycol (PBET/BDO/PAOG or PBET/PAOG), or a portion of the diacid is replaced with isophthalic acid (PBET/I) or adipic acid (PBET/ADA). In the case of direct esterification of BEDO with terephthalic acid, then the acid form of the comonomers is used.

For use as a layer in a multilayer article, copolymers with BDO are preferred. In order to produce copolymers from DMT or TA, the level of BDO is preferably greater than 20 mole % of the diols. Lower amounts of BDO were found to give a less crystalline copolymer which was more difficult to cut into pellets after extrusion and quenching the polymer strands. The molar ratio of BDO/BEDO controls the oxygen scavenging capacity of the copolymer that is required for the end use of the multilayer article. The range of the mole fraction of BDO is preferably between 0.2 and 0.75 of the diols.

As noted in the discussion of the prior art, all current oxygen scavenging (OS) polymers give haze in containers in which these OS polymers are blended with PET, or copolymers of PET, which makes them unacceptable for clear monolayer containers. In such blends either colorants are added to mask the haze, for example in beer bottles, or only a low amount of OS polymer can be blended with the base polymer to limit the increase in haze, with the consequent limit on oxygen scavenging capacity.

Many copolymers based on BEDO as the oxygen scavenging moiety were prepared. As copolymers for use in multilayer articles, where haze is not a problem, these can easily be designed for optimum oxygen scavenging capacity. However many of the same copolymers when blended with PET, or PET copolymers, either gave a clear container with low oxygen scavenging capacity, or a hazy container with good oxygen scavenging capacity. After extensive research, the inventor discovered that by including poly(alkylene oxide) glycols to produce a copolymer with BEDO and BDO as the diols, and DMT or TA as the dicarboxylic acid, gave a polymer which gave high oxygen scavenging capacity and low haze when blended with PET and PET copolymers.

Examples of poly(alkylene oxide) glycols include poly(ethylene oxide) glycol, poly(1,2 and 1,3-propylene oxide) glycol, poly(tetramethylene oxide) glycol (PTMEG), poly(pentamethylene oxide) glycol, poly(hexamethylene oxide) glycol, poly(heptamethylene oxide) glycol, poly(octamethylene oxide) glycol, poly(nonamethylene oxide) glycol, poly(decamethylene oxide) glycol and random or block copolymer glycols of the above alkylene oxides. Preferred poly(alkylene oxide) glycols include poly(ethylene glycol), random copoly (ethylene oxide-tetramethylene oxide) glycols, and poly(tetramethylene glycol. Poly(alkylene oxide) glycol having number average molecular weights in the range of about 500 to about 3,500 g/mole is preferred. At lower molecular weights bottles prepared with these OS copolymers blended with PET and PET copolymers were hazy and exhibited low oxygen permeability, and at higher poly(alkylene oxide) glycol molecular weights the OS copolyester/PET blends gave higher haze in the article. The most preferred range of poly(alkylene oxide) glycol molecular weight is 1000 to 3500 g/mole. As a mole percent of the diols in these OS polyesters based on BEDO, the poly(alkylene oxide) glycol is preferably in the range of 5 to 25%. Poly(alkylene oxide) glycol used outside this range did not provide an OS copolyester with the optimum balance of clarity and oxygen permeability.

Use of a transition metal catalyst to improve the oxygen scavenging efficiency in certain copolyesters can be used. A cobalt compound is preferred. The cobalt transition metal catalyst contemplated herein is not the other transition metal catalyst that may be used in the manufacturing of the OS polymer or copolymer, nor in the manufacturing of any base polymer that may be blended with the OS polymer or copolymer. Suitable cobalt compounds for use with the present invention include cobalt acetate, cobalt carbonate, cobalt chloride, cobalt hydroxide, cobalt naphthenate, cobalt oleate, cobalt linoleate, cobalt octoate, cobalt stearate, cobalt nitrate, cobalt phosphate, cobalt sulfate, cobalt (ethylene glycolate), and mixtures of two or more of these, among others. As a transition metal catalyst for active oxygen scavenging, a salt of a long chain fatty acid is preferred, cobalt octoate or stearate being the most preferred, in an amount of up to 300 ppm, based on the amount of OS polymer or copolymer. The transition metal catalyst is merely blended with the OS polymer or copolymer. If introduced during polymerization it is preferably added at the end of polycondensation of the OS polymer or copolymer, such that it does not affect any manufacturing reactions, prior to and including polycondensation. However introduction of this catalyst into the composition is preferably achieved by preparing a separate master batch with the base resin that is added at the throat of the extruder together with the blend of the OS polymer or copolymer with the base resin. This method prevents the OS polymer or copolymer from being active until the article is extruded.

While not wishing to be bound by theory, it is believed that oxygen scavenging polymers for blending with conventional polymers (that are commercially used in the packaging industry, such as polyesters, polyamides, polyolefins, polycarbonates and poly(ethylene vinyl alcohol)), need to be partially miscible. If they are too miscible the blend gives a clear article and the base polymer and OS polymer form a quasi-interpenetrating network, but the groups (e.g. allylic or benzylic hydrogen) in the oxidizable polymer are not then readily available to be oxidized. On the other hand, if the blend is too immiscible the domains of the OS polymer cause haziness in the article, but the OS polymer can function as designed.

Depending on the type of OS polymer or copolymer of the present invention, the OS polymer or copolymer can be blended with the conventional base polymer such as polyesters, polyamides, and polypropylene in an amount up to 45 wt % of the blend. However the typical blend is from about 0.2 to about 10 wt % OS polymer or copolymer with the base polymer.

The polyesters commercially used for packaging are the base polymer to which the OS polyesters of this invention are blended for monolayer packaging articles. Suitable base polyesters are produced from the reaction of a diacid or diester component comprising at least 65 mol- % terephthalic acid or C₁-C₄ dialkylterephthalate, preferably at least 70 mol- %, more preferably at least 75 mol- %, even more preferably, at least 95 mol- %, and a diol component comprising at least 65% mol-% ethylene glycol, preferably at least 70 mol- %, more preferably at least 75 mol- %, even more preferably at least 95 mol- %. It is also preferable that the diacid component is terephthalic acid and the diol component is ethylene glycol, thereby forming polyethylene terephthalate (PET). The mole percent for all the diacid component totals 100 mol- %, and the mole percentage for all the diol component totals 100 mol- %.

Where the base polyester components are modified by one or more diol components other than ethylene glycol, suitable diol components of the described polyester may be selected from 1,4-cyclohexandedimethanol, 1,2-propanediol, 1,4-butanediol, 2,2-dimethyl-1,3-propanediol, 2-methyl-1,3-propanediol (2MPDO) 1,6-hexanediol, 1,2-cyclohexanediol, 1,4-cyclohexanediol, 1,2-cyclohexanedimethanol, 1,3-cyclohexanedimethanol, and diols containing one or more oxygen atoms in the chain, e.g., diethylene glycol, triethylene glycol, dipropylene glycol, tripropylene glycol or mixtures of these, and the like. In general, these diols contain 2 to 18, preferably 2 to 8 carbon atoms. Cycloaliphatic diols can be employed in their cis or trans configuration or as mixture of both forms. Preferred modifying diol components are 1,4-cyclohexanedimethanol or diethylene glycol, or a mixture of these.

Where the base polyester components are modified by one or more acid components other than terephthalic acid, the suitable acid components (aliphatic, alicyclic, or aromatic dicarboxylic acids) of the linear polyester may be selected, for example, from isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, 2,6-naphthalenedicarboxylic acid, bibenzoic acid, or mixtures of these and the like. In the polymer preparation, it is often preferable to use a functional acid derivative thereof such as the dimethyl, diethyl, or dipropyl ester of the dicarboxylic acid. The anhydrides or acid halides of these acids also may be employed where practical. These acid modifiers generally retard the crystallization rate compared to terephthalic acid.

Also particularly contemplated by the present invention is a base polyester resin made by reacting at least 85 mol- % terephthalate from either terephthalic acid or dimethyl-terephthalate with any of the above comonomers.

In addition to a base polyester resin made from terephthalic acid (or dimethyl terephthalate) and ethylene glycol, or a modified polyester as stated above, the present invention also includes the use of 100% of an aromatic diacid such as 2,6-naphthalene dicarboxylic acid or bibenzoic acid, or their diesters, and a modified polyester made by reacting at least 85 mol- % of the dicarboxylate from these aromatic diacids/diesters with any of the above comonomers.

Although not required, additives may be used in these blends. Conventional known additives include, but are not limited to an additive of a dye, pigment, filler, branching agent, reheat agent, anti-blocking agent, antioxidant, anti-static agent, biocide, blowing agent, coupling agent, flame retardant, heat stabilizer, impact modifier, UV and visible light stabilizer, crystallization aid, lubricant, plasticizer, processing aid, acetaldehyde and other scavengers, and slip agent, or a mixture thereof.

The blend of base polyester, BEDO copolyester and optionally the transition metal salt, is conveniently prepared by adding the components at the throat of the injection molding machine that: (i) produces a preform that can be stretch blow molded into the shape of the container, (ii) a sheet that can be thermoformed, or (iii) a film. Another method is to prepare a master batch of the base polyester with the BEDO copolyester, and optionally the transition metal catalyst. This master batch can then be blended with the base polymer. Preferably if a transition metal catalyst is used, a master batch of the catalyst and the base polymer is prepared, and added as a third component (the base polyester, the BEDO copolyester, and the transition metal catalyst master batch) at the throat of the injection molding machine. The mixing section of the extruder should be of a design to produce a homogeneous blend.

In general, the present invention relates to a composition and system which scavenges oxygen and is therefore useful in improving the shelf life of packaged oxygen-sensitive products such as pharmaceuticals, cosmetics, chemicals, electronic devices, health and beauty products, and pesticides, as well as food and beverage products. The present system can be used in films, moldings, coatings, patches, bottle cap inserts and molded or thermoformed shapes, such as bottles and trays. In particular it relates to injection stretch blow molded containers, both mono-layer and multilayer. The blends of conventional base polymers and OS polymers or copolymers may be employed both in monolayer containers or multilayer containers, depending on the haze. Low haze blends can be employed in either situation, while those blends that have more haze are generally suitable only for multilayer containers. In all of these applications, the scavenger system effectively scavenges any oxygen, whether it comes from the headspace of the packaging, is entrained in the food or product, or is from outside the package.

Blending different amounts of these polyesters containing allylic hydrogen atoms with saturated polyesters, such as polyethylene terephthalate (PET) and its copolymers, allows the oxygen scavenging efficiency of the article to be controlled.

### TEST PROCEDURES

1. Oxygen Scavenging Efficiency

A headspace oxygen analyzer (model 6500) from Illinois Instruments was used in this study. The principle of the headspace oxygen analyzer was used according to the following procedure:
1. The samples were ground cryogenically using liquid nitrogen and passed through a #25 sieve for analysis.
2. 1.5 g (±0.05 g) of the sample was weighed into a 25 ml flask and sealed. The analysis was conducted in triplicate for each test period (24, 48 & 72 hours).
3. The flasks were placed in a 70° C. oven.
4. The instrument was calibrated with ambient air (20.9% oxygen) at the beginning of each analysis session, and the oxygen level of the air measured in the sealed flasks after each test period. The average of the three measurements was recorded.

2. Oxygen Permeability of Films

Oxygen flux of film samples, at zero percent relative humidity, at one atmosphere pressure, and at 25° C. was measured with a Mocon Ox-Tran model 2/20 (MOCON Minneapolis, Minn.). A mixture of 98% nitrogen with 2% hydrogen was used as the carrier gas, and 100% oxygen was used as the test gas. Prior to testing, specimens were conditioned in nitrogen inside the unit for a minimum of twenty-four hours to remove traces of atmospheric oxygen dissolved in the PET matrix. The conditioning was continued until a steady base line was obtained where the oxygen flux changed by less than one percent for a thirty-minute cycle. Subsequently, oxygen was introduced to the test cell. The test ended when the flux reached a steady state where the oxygen flux changed by less than 1% during a 30 minute test cycle, normally after 72 hours, unless otherwise stated. Calculation of the oxygen permeability was done according to a literature method for permeation coefficients for PET copolymers, from Fick's second law of diffusion with appropriate boundary conditions. The literature documents are: Sekelik et al., Journal of Polymer Science Part B: Polymer Physics, 1999, Volume 37, Pages 847-857. The second literature document is Qureshi et al., Journal of Polymer Science Part B: Polymer Physics, 2000, Volume 38, Pages 1679-1686. The third literature document is Polyakova, et al., Journal of Polymer Science Part B: Polymer Physics, 2001, Volume 39, Pages 1889-1899.

All film permeability values are reported in units of (cc.cm)/(m².atm.day)).

3. Haze

The haze of the preform and bottle walls was measured with a Hunter Lab ColorQuest II instrument. D65 illuminant was used with a CIE 1964 10° standard observer. The haze is defined as the percent of the CIE Y diffuse transmittance to the CIE Y total transmission. Unless otherwise stated the % haze is measured on the sidewall of a stretch blow molded bottle having a thickness of 0.25 mm.

4. Metal Content

The metal content of the ground polymer samples was measured with an Atom Scan 16 ICP Emission Spectrograph. The sample was dissolved by heating in ethanolamine, and on cooling, distilled water was added to crystallize out the terephthalic acid. The solution was centrifuged, and the supernatant liquid analyzed. Comparison of atomic emissions from the samples under analysis with those of solutions of known metal ion concentrations was used to determine the experimental values of metals retained in the polymer samples. This method is used to determine the cobalt concentration in the composition.

5. Preform and Bottle Process

Unless otherwise stated, the OS polymers and copolymers of the present invention are typically dried for about 30 hours at 90-110° C., blended with the dried base resin and a dried master batch of the transition metal catalyst, melted and extruded into preforms. Each preform for a 0.5 liter soft drink bottle, for example, employs about 24-25 grams of the resin. The preform is then heated to about 100-120° C. and blow-molded into a 0.5 liter contour bottle at a stretch ratio of about 12.5. The sidewall thickness is 0.25 mm.

### EXAMPLES

### Example 1

DMT (242.7 g, 1.25 mole), Butenediol (2-butene-1,4diol, 95% cis) (242 g, 2.75 mole) and Tetrabutyl titanate (0.094 g, 48 ppm Ti based on polymer) were charged into an autoclave. The ester interchange temperature was 185-190° C., for 60 minutes, and the polycondensation temperature was set as 205° C. for 120 minutes. Cobalt Stearate was added in certain examples at the end of the polymerization, and reported as ppm Co. Copolymers were prepared by replacing some of the butenediol with 1,4-butanediol (BDO), or some of the DMT with dimethyl isophthalate. Both PET and polybutylene terephthalate (PBT) were used as controls.

Table 1 shows the components in the various polyesters and copolyesters prepared.

TABLE 1

| | | Ethylene | 1,4-butane | 2-butene- | Terephthalic | Isophthalic |
|---|---|---|---|---|---|---|
| | | Glycol | diol | 1,4 diol | acid | acid |
| | | mole | mole | mole | mole | mole |
| Run | ID | fraction | fraction | fraction | fraction | fraction |
| 1 | PET | 0.5 | 0 | 0 | 0.4875 | 0.0125 |
| 2 | PET * | 0.5 | 0 | 0 | 0.4875 | 0.0125 |
| 3 | PBET | 0 | 0 | 0.5 | 0.5 | 0 |
| 4 | PBET * | 0 | 0 | 0.5 | 0.5 | 0 |
| 5 | PBT | 0 | 0.5 | 0 | 0.5 | 0 |
| 6 | PBT * | 0 | 0.5 | 0 | 0.5 | 0 |
| 7 | PBET/BDO (75/25) | 0 | 0.125 | 0.375 | 0.5 | 0 |
| 8 | PBET/BDO (75/25) * | 0 | 0.125 | 0.375 | 0.5 | 0 |
| 9 | PBET/BDO (50/50) | 0 | 0.25 | 0.25 | 0.5 | 0 |
| 10 | PBET/BDO (50/50) * | 0 | 0.25 | 0.25 | 0.5 | 0 |
| 11 | PBET/I (75/25) | 0 | 0 | 0.5 | 0.375 | 0.125 |
| 12 | PBET/I (75/25) * | 0 | 0 | 0.5 | 0.375 | 0.125 |
| 13 | PBET/I (60/40) | 0 | 0 | 0.5 | 0.3 | 0.2 |
| 14 | PBET/I (60/40) * | 0 | 0 | 0.5 | 0.3 | 0.2 |

ID with * contain 100 ppm Co

The results of the oxygen scavenging, together with a known oxygen scavenger MXD6 (6007 resin from Mitsubishi Gas Chemicals), with (*) and without 100 ppm cobalt stearate, is set forth in Table 2.

TABLE 2

| | | Days | | |
|---|---|---|---|---|
| | | 1 | 2 | 3 |
| Run | ID | O₂, % | | |
| 1 | PET | 20.2 | 20.1 | 20 |
| 2 | PET * | 20.1 | 20 | 19.9 |
| 3 | PBET | 19.8 | 18.9 | 16.7 |
| 4 | PBET * | 0 | 0 | 0 |
| 5 | PBT | 19.6 | 19.6 | 19.5 |
| 6 | PBT * | 18.1 | 18.1 | 18.1 |
| 7 | PBET/BDO (75/25) | 20.1 | 19.9 | 19.7 |
| 8 | PBET/BDO (75/25) * | 0 | 0 | 0 |
| 9 | PBET/BDO (50/50) | 19.6 | 19.6 | 19.5 |
| 10 | PBET/BDO (50/50) * | 0 | 0 | 0 |
| 11 | PBET/I (75/25) | 17.4 | 7.5 | 0 |
| 12 | PBET/I (75/25) * | 0 | 0 | 0 |
| 13 | PBET/I (60/40) | 11.8 | 0 | 0 |
| 14 | PBET/I (60/40) * | 0 | 0 | 0 |
| 15 | MXD6 | 19.9 | 19.7 | 19.6 |
| 16 | MXD6 * | 15.6 | 12.5 | 9.1 |

ID with * contain 100 ppm cobalt

PBET and its copolymers with butane diol are fast active oxygen scavengers in the presence of cobalt, completely scavenging the oxygen in the flask within a day. The copolyesters with isophthalic acid scavenge oxygen at an even faster rate that the homopolymer, and do not need a transition metal catalyst. Relative to the industry standard MXD6, these polyesters are more efficient scavengers.

The copolymer of run #8 and PET (run #1) were compressed, at 175° C., into films of 0.25 mm thickness. The amorphous film of the PBET/BDO (75/25) containing 100 ppm cobalt had zero oxygen permeability compared to 0.45 (cc.cm)/(m².atm.day)) for the PET film.

Blends with PET were made by compounding with a Haake twin screw extruder at 265° to 270° C. The results of blending some of these polymers at the 20 wt-% level with PET (INVISTA Type 2201) are set forth in Table 3.

TABLE 3

| | | | Days | | | |
|---|---|---|---|---|---|---|
| | Polymer | | 1 | 3 | 7 | 14 |
| Run | (Table 1) | ID | O₂, % | | | |
| 17 | 3 | PBET | 20.6 | 20.2 | 20.2 | 19 |
| 18 | 4 | PBET * | 19 | 14 | 10.3 | 9.2 |
| 19 | 7 | PBET/BDO (75/25) | 20.5 | 20.3 | 20.2 | 19.2 |
| 20 | 8 | PBET/BDO (75/25) * | 18.4 | 13.7 | 9.4 | 8.9 |

ID with * contain 100 ppm cobalt

These results illustrate that these polyesters, and copolyesters, can be blended with other polymers and retain their oxygen scavenging efficiency, allowing a means to control the oxygen scavenging efficiency of the article formed from these compositions.

### Example 2

Bottles were prepared from blends of PBET, prepared according to the method of Example 1, with PET (INVISTA Type 2201). The oxygen permeability and sidewall haze were measured and the results set forth in Table 4.

TABLE 4

| | | | | Oxygen | Oxygen |
|---|---|---|---|---|---|
| | | | | Permeability | Permeability |
| | | | | (cc · cm/m²/ | (cc · cm/m²/ |
| PET | PBET | Cobalt | Haze | day/atm) | day/atm) |
| Wt % | Wt % | (ppm) | (%) | after 7 days | after 21 days |
| 100 | 0 | 0 | 2 | 0.188 | 0.188 |
| 95 | 5 | 100 ¹ | 4.4 | 0.004 | 0.157 |
| 90 | 10 | 100 ¹ | 11.7 | 0.175 | |
| 95 | 5 | 50 ² | 5.8 | 0.002 | 0.164 |
| 90 | 10 | 50 ² | 11.5 | 0.149 | |
| 99 | 1 | 100 | 3.9 | 0.166 | |
| 98 | 2 | 100 | 3.5 | 0.177 | |

¹ cobalt octoate
² cobalt stearate

It was unexpected that while a blend with 5 wt. % of PBET had low oxygen permeability after 7 days, increasing the PBET to 10 wt. % in essence showed no oxygen scavenging activity and additionally increased the bottle haze to unacceptable levels.

### Example 3

Copolymers of PBET with various amounts of BDO (PBET/BDO) were prepared in accordance with the procedure of Example 1. The compositions are listed in Table 5.

TABLE 5

| | DMT | Butenediol | Butanediol | Cobalt |
|---|---|---|---|---|
| Sample ID | Mole % | Mole % | Mole % | ppm |
| 21 | 100 | 100 | 0 | 0 |
| 22 | 100 | 100 | 0 | 100 |
| 23 | 100 | 95 | 5 | 0 |
| 24 | 100 | 85 | 15 | 0 |
| 25 | 100 | 75 | 25 | 0 |
| 26 | 100 | 75 | 25 | 100 |
| 27 | 100 | 50 | 50 | 0 |
| 28 | 100 | 50 | 50 | 100 |
| 29 | 100 | 25 | 75 | 0 |
| 30 | 100 | 0 | 100 | 0 |
| 31 | 100 | 0 | 100 | 100 |

Headspace analysis was conducted on some of these copolymers and the results are set forth in Table 6.

TABLE 6

| | Headspace O₂, (%) | | |
|---|---|---|---|
| Sample ID | Day 1 | Day 2 | Day 3 |
| 21 | 19.8 | 18.9 | 16.7 |
| 22 | 0 | 0 | 0 |
| 25 | 20.1 | 19.9 | 19.7 |
| 26 | 0 | 0 | 0 |
| 27 | 19.6 | 19.6 | 19.5 |
| 28 | 0 | 0 | 0 |

These results show that a transition metal catalyst is required for these specific copolymers of PBET with butane diol for oxygen scavenging activity.

These PBET/BDO copolymers were blended at various levels with PET and bottles produced. The haze and oxygen permeability was measured and the results set forth in Table 7.

TABLE 7

| | | | | | Oxygen |
|---|---|---|---|---|---|
| | PBET | | | | Permeation |
| | copolymer | PBET | | | after 2 weeks |
| PET | (mole % | copolymer | Cobalt | | (cc · cm)/ |
| Wt % | BDO) | Wt % | (ppm) | Haze (%) | (m² · atm · day) |
| 98 | 75 | 2 | 100 | 1.6 | 0.182 |
| 98 | 50 | 2 | 100 | 1.9 | 0.161 |
| 98 | 25 | 2 | 100 | 1.2 | 0.186 |
| 95 | 25 | 5 | 100 | 3.2 | 0.169 |
| 95 | 50 | 5 | 100 | 3.2 | 0.167 |
| 95 | 15 | 5 | 100 | | 0.173 |
| 95 | 25 | 5 | 50 | 2.6 | 0.161 |
| 95 | 25 | 5 | 100 | 3.4 | 0.178 |
| 95 | 25 | 5 | 150 | 3.5 | 0.168 |
| 95 | 25 | 5 | 200 | 3.4 | 0.207 |
| 95 | 25 | 5 | 250 | 4.9 | 0.192 |
| 95 | 25 | 5 | 300 | 4.4 | 0.187 |
| 95 | 25 | 5 | 0 | 3.4 | 0.183 |
| 95 | 25 | 5 | 10 | 2.4 | 0.161 |
| 95 | 25 | 5 | 100 | | 0.196 |
| 95 | 25 | 5 | 10 | | 0.191 |
| 95 | 25 | 5 | 30 | | 0.195 |
| 90 | 25 | 10 | 100 | | 0.195 |
| 85 | 25 | 15 | 100 | | 0.195 |
| 70 | 25 | 30 | 100 | | 0.094 |
| 70 | 25 | 30 | 100 | | 0.137 |
| 60 | 25 | 40 | 100 | | 0.028 |
| 60 | 25 | 40 | 100 | | 0.079 |
| 50 | 25 | 50 | 100 | | 0.0038 |

Significant improvement in oxygen permeability is seen at 30 and higher weight % blends of these PBET/BDO copolymers with PET.

### Example 4

PBET/I copolymers were made from DMT, 2-butene-1,4-diol and isophthalic acid (IPA), the IPA was added after the ester interchange reaction. The results of the headspace analysis are set forth in Table 8.

TABLE 8

| IPA, in | | | | |
|---|---|---|---|---|
| PBET | Cobalt, ppm | | | |
| copolymer, | of | Headspace O₂, % | | |
| mole % | copolymer | Day 1 | Day 2 | Day 3 |
| 25 | 0 | 17.4 | 7.5 | 0 |
| 25 | 100 | 0 | 0 | 0 |
| 40 | 0 | 11.8 | 0 | 0 |
| 40 | 100 | 0 | 0 | 0 |

Bottle sidewalls containing blends of 5 wt. % of these IPA copolymers with cobalt and PET did not show lower oxygen permeability after 3 weeks.

### Example 5

PBET copolymers were made from DMT, 2-butene-1,4-diol and adipic acid (ADA), the ADA was added after the ester interchange reaction. The copolymers were blended with a master batch of cobalt stearate in PET to give 100 ppm Co in the composition. Bottles were prepared by blending with PET. The oxygen permeability and haze of the bottle sidewalls was measured after three weeks and the results set forth in Table 9.

TABLE 9

| ADA in PBET | Copolymer in | | Oxygen Permeability, |
|---|---|---|---|
| copolymer, | blend, | Haze | (cc · cm)/(m² · atm · day), |
| mole % | Weight % | (%) | after 3 weeks |
| 5 | 10 | 3.6 | 0.183 |
| 5 | 20 | 4.8 | 0.046 |
| 10 | 10 | 4.9 | 0.168 |
| 10 | 20 | 9.8 | 0.088 |
| 15 | 10 | 6.2 | 0.158 |
| 15 | 20 | 9.5 | 0.083 |

Excellent oxygen permeability was measure with 20 wt. % of the PBET copolymer containing 5 mole % of adipic acid.

### Example 6

PBET copolymers were made from DMT, 2-butene-1,4-diol and neopentyl glycol (NPG), the NPG was added with the other monomers. The copolymers were blended with a master batch of cobalt stearate in PET to give 100 ppm Co in the composition. Bottles were prepared by blending 5 weight % with PET. The oxygen permeability and haze of the bottle sidewalls was measured after one week and the results set forth in Table 10.

TABLE 10

| | | |
|---|---|---|
| NPG in copolymer, | Haze | Oxygen Permeability |

| mole % | (%) | After 1 week | After 3 weeks |
|---|---|---|---|
| 5 | 2.0 | 0.118 | 0.209 |
| 10 | 2.5 | 0.096 | 0.207 |
| 15 | 2.8 | 0.128 | 0.209 |

Although good oxygen scavenging was observed after 1 week, the permeability was the same as a PET control after 3 weeks.

### Example 7

PBET copolymers were made from DMT, 2-butene-1,4-diol and poly(tetramethylene glycol) (PTMEG) of different molecular weights (Terathane®, INVISTA), the PTMEG was added with the other monomers. The copolymers were blended with a master batch of cobalt stearate in PET to give 140 ppm Co in the composition. Bottles were prepared by blending various amounts of this copolymer with PET. The oxygen permeability and haze of the bottle sidewalls was measured and the results set forth in Table 11.

TABLE 11

| | | PBET | | |
|---|---|---|---|---|
| PTMEG | | Copolymer | | Oxygen |
| Molecular | Mole % of | (wt. % in | Haze, | Permeability |
| wt. | diol | blend) | (%) | (cc · cm/m²/day/atm) |
| 250 | 10 | 0.5 | 6.1 | .211 |
| 250 | 10 | 1 | 6.9 | .211 |
| 250 | 10 | 2 | 11.0 | .217 |
| 250 | 10 | 5 | 18.6 | .215 |
| 650 | 10 | 0.5 | 24.3 | .101 |
| 650 | 10 | 1 | 34.4 | .045 |
| 650 | 15 | 0.5 | 36.9 | .158 |
| 650 | 15 | 1 | 36.6 | .050 |
| 650 | 15 | 2 | 14.9 | 0.000 |
| 650 | 15 | 5 | 30.0 | 0.002 |

These results indicate that as the molecular weight of the PTMEG increased, the oxygen permeability of the bottle sidewall decreased, but haze was still an issue (much worse than the PET control).

### Example 8

PBET copolymers were made from DMT, 2-butene-1,4-diol, 1,4-butane diol (BDO) and 10 mole % (based on diols) of PTMEG with a molecular weight of 1000 (Terathane®, INVISTA). The copolymers were blended with a master batch of cobalt stearate in PET to give either 140 ppm or 200 ppm Co in the composition. Bottles were prepared by blending various amounts of this copolymer with PET. The oxygen permeability and haze of the bottle sidewalls was measured and the results set forth in Table 12.

TABLE 12

| | | | | | Oxygen |
|---|---|---|---|---|---|
| Butene | Butane | | Copolymer | | Permeability |
| diol | diol | Cobalt | (wt. % in | Haze, | (cc · cm/ |
| (mole %) | (mole %) | ppm | blend) | (%) | m²/day/atm) |
| 70 | 20 | 140 | 0.5 | 2.8 | 0.017 |
| 70 | 20 | 200 | 0.5 | 3.1 | 0.003 |
| 70 | 20 | 140 | 1 | 5.8 | 0.005 |
| 70 | 20 | 200 | 1 | 4.9 | 0.000 |
| 70 | 20 | 140 | 2 | 13.4 | 0.004 |
| 70 | 20 | 200 | 2 | 9.8 | 0.000 |
| 50 | 40 | 140 | 0.5 | 2.8 | 0.011 |
| 50 | 40 | 200 | 0.5 | 2.5 | 0.002 |
| 50 | 40 | 140 | 1 | 4.3 | 0.000 |
| 50 | 40 | 200 | 1 | 4.2 | 0.000 |
| 50 | 40 | 140 | 2 | 7.4 | 0.003 |
| 50 | 40 | 200 | 2 | 7.8 | 0.000 |

This example demonstrated that using 10 mole % (based on total diols) of PTMEG with a molecular weight of 1000 gave a copolymer that when blended with PET, even at a loading as low as 0.5 weight %, achieved the objective of providing a stretch blow molded bottle with essentially zero oxygen permeation and a haze level comparable to the control PET bottle (2.5%).

### Example 9

The same series of copolymers as in Example 8 were prepared with the exception that the 10 mole % PTMEG of molecular weight 1000 g/mole was replaced with a random copoly(ethylene oxide-tetramethylene oxide) glycol, incorporating 50 mole % ethylene oxide, (INVISTA Terathane® E) of the same molecular weight. The oxygen permeability and haze of the bottle sidewalls was measured and the results set forth in Table 13.

TABLE 13

| | | | | | Oxygen |
|---|---|---|---|---|---|
| Butene | Butane | | Copolymer | | Permeability |
| diol | diol | Cobalt | (wt. % in | Haze, | (cc · cm/ |
| (mole %) | (mole %) | ppm | blend) | (%) | m²/day/atm) |
| 70 | 20 | 140 | 0.5 | 2.6 | 0.184 |
| 70 | 20 | 200 | 0.5 | 3.5 | 0.004 |
| 70 | 20 | 140 | 1 | 6.2 | 0.000 |
| 70 | 20 | 200 | 1 | 4.5 | 0.001 |
| 70 | 20 | 140 | 2 | 7.4 | 0.000 |
| 70 | 20 | 200 | 2 | 8.0 | 0.000 |
| 50 | 40 | 140 | 0.5 | 3.2 | 0.156 |
| 50 | 40 | 200 | 0.5 | 3.3 | 0.183 |
| 50 | 40 | 140 | 1 | 4.1 | 0.019 |
| 50 | 40 | 200 | 1 | 4.6 | 0.102 |
| 50 | 40 | 140 | 2 | 7.1 | 0.000 |
| 50 | 40 | 200 | 2 | 6.4 | 0.000 |

The balance of haze and oxygen permeability of the random copoly(alkylene oxide) glycol was comparable to that of the poly(alkylene oxide) glycol in Example 8

### Example 10

PBET copolymers were made from DMT, 2-butene-1,4-diol, 1,4-butane diol (BDO) and 10 mole % (based on diols) of PTMEG with molecular weights of 1400 and 2000 g/mole (Terathane®, INVISTA). The copolymers were blended with a master batch of cobalt stearate in PET to give 140 ppm of Co in the composition. Bottles were prepared by blending various amounts of this copolymer with PET. The oxygen permeability and haze of the bottle sidewalls was measured and the results set forth in Table 14.

TABLE 14

| | | | | | Oxygen |
|---|---|---|---|---|---|
| Butene | Butane | PTMEG, | Copolymer | | Permeability |
| diol | diol | molecular | (wt. % in | Haze, | (cc · cm/ |
| (mole %) | (mole %) | wt. g/mole | blend) | (%) | m²/day/atm) |
| 70 | 20 | 1400 | 0.5 | 2.6 | 0.018 |
| 70 | 20 | 1400 | 1 | 6.2 | 0.001 |
| 70 | 20 | 1400 | 2 | 10.8 | 0.000 |
| 50 | 40 | 1400 | 0.5 | 2.8 | 0.001 |
| 50 | 40 | 1400 | 1 | 4.3 | 0.000 |
| 50 | 40 | 1400 | 2 | 9.5 | 0.000 |
| 50 | 40 | 2000 | 0.5 | 2.7 | 0.000 |
| 50 | 40 | 2000 | 1 | 4.0 | 0.000 |
| 50 | 40 | 2000 | 2 | 8.9 | 0.000 |

Improved haze and lower permeability was observed at higher poly(alkylene oxide) glycol molecular weights.

### Example 11

PBET copolymers were made from DMT, 2-butene-1,4-diol, 1,4-butane diol (BDO) and various amounts of a random copoly(ethylene oxide-tetramethylene oxide) glycol, incorporating 50 mole % ethylene oxide, (INVISTA Terathane® E) of molecular weight 2000 g/mole (COPE). The copolymers were blended with a master batch of cobalt stearate in PET to give 140 ppm of Co in the composition. Bottles were prepared by blending various amounts of this copolymer with PET. The oxygen permeability of the bottle sidewalls was measured and the results set forth in Table 15.

TABLE 15

| | | | | Oxygen |
|---|---|---|---|---|
| | | | Copolymer | Permeability |
| Butene diol | Butane diol | COPE, | (wt. % in | (cc · cm/ |
| (mole %) | (mole %) | (mole %) | blend) | m²/day/atm) |
| 77 | 20 | 3 | 0.5 | 0160 |
| 77 | 20 | 3 | 1 | 0.068 |
| 77 | 20 | 3 | 2 | 0.000 |
| 77 | 20 | 3 | 5 | 0.000 |
| 75 | 20 | 5 | 0.5 | 0187 |
| 75 | 20 | 5 | 1 | 0.064 |
| 75 | 20 | 5 | 2 | 0.001 |
| 75 | 20 | 5 | 5 | 0.002 |
| 70 | 20 | 10 | 0.5 | 0.165 |
| 70 | 20 | 10 | 1 | 0.004 |
| 70 | 20 | 10 | 2 | 0.000 |
| 70 | 20 | 10 | 5 | 0.000 |

At a 1 wt-% blend level, the lowest permeability was observed with this copoly(alkylene oxide) glycol at a 10 mole %, based on diols, of the diol component of the oxygen scavenging copolyester.

Thus it is apparent that there has been provided in accordance with the invention, a composition and method that fully satisfy the objects, aims and advantages set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

1. An oxygen scavenging polyester composition, comprising the reaction product of linear difunctional monomer and, dicarboxylic acid or its ester equivalent, said monomer having the general formula:
X—(CH₂)ₙ—CH═CH—(CH₂)ₘ—X′
wherein X and X′ are each independently selected from the group consisting of OR and COOR, wherein R is selected from H and alkyl groups with one or more carbon atoms; and n and m are each independently 1 or more.

2. The oxygen scavenging composition of claim 1, wherein said monomer is 2-butene-1,4-diol and said dicarboxylic acid is terephthalic acid or its ester equivalent.

3. The oxygen scavenging composition of claim 2, wherein said product is a copolymer, wherein up to 75 mol %, based on total diols, of said monomer is replaced with other diols, wherein said other diols are selected from 1,4-butane diol (BDO), neopentyl glycol, 2-methyl-1,3-propanediol, cyclohexanedimethanol, or poly(alkylene oxide) glycols, and wherein up to 50 mol %, based on total diacids, of said terephthalic acid or its ester equivalent is replaced with other dicarboxylic acids or their ester equivalents, wherein said other dicarboxylic acid or their ester equivalents are selected from isophthalic acid, naphthoic acid, adipic acid, or their ester equivalents, or the anhydride of the acid.

4. (canceled)

5. The oxygen scavenging composition of claim 3, wherein said poly(alkylene oxide) glycol has a molecular weight in the range of 500 to 3500 mole/g.

6. (canceled)

7. (canceled)

8. The oxygen scavenging composition of claim 1, wherein said reaction product is a copolymer of 2-butene-1,4-diol and 1,4-butane-diol with terephthalic acid or its ester equivalent.

9. The oxygen scavenging composition of claim 8, wherein said 1,4-butane-diol is present in an amount of at least 20 mol. %.

10. The oxygen scavenging composition of claim 1, wherein said reaction product is a copolymer of 2-butene-1,4-diol, 1,4-butane diol and a poly(alkylene oxide) glycol with terephthalic acid or its ester equivalent, wherein said poly(alkylene oxide) glycol is selected from the group consisting of poly(tetramethylene oxide) glycol and random copoly(ethylene oxide—tetramethylene oxide) glycol.

11. (canceled)

12. The oxygen scavenging composition of claim 10, wherein said poly(alkylene oxide) glycol has a molecular weight in the range of 500 to 3500 mole/g.

13. The oxygen scavenging composition of claim 1, including a transitional metal catalyst.

14. The oxygen scavenging composition of claim 13, wherein said transitional metal catalyst is selected from cobalt acetate, cobalt carbonate, cobalt chloride, cobalt hydroxide, cobalt naphthenate, cobalt oleate, cobalt linoleate, cobalt octoate, cobalt stearate, cobalt nitrate, cobalt phosphate, cobalt sulfate, cobalt (ethylene glycolate), and mixtures of two or more of these.

15. The oxygen scavenging composition of claim 14, wherein said catalyst is present in an amount up to about 300 ppm based on the amount of the cobalt.

16. A polymer comprising blends of the oxygen scavenging compositions of claim 14 with polyesters, polyamides or polyolefins.

17. The polymer of claim 16, wherein said blend comprises up to about 45 wt. % oxygen scavenging compositions.

18. The polymer of claim 16, wherein transition metal catalyst is present in an amount of up to about 300 ppm, based on the weight of said oxygen scavenging composition.

19. An articles made from said composition of claim 1, wherein said article is a fiber, film, preform or container, wherein said preform or container is monolayer or multilayer.

20. An article made from the polymer of claim 16, wherein said article is a fiber, a film, a preform or a container, wherein said preform or container is monolayer or multilayer.

21. (canceled)

22. The article of claim 20, wherein the sidewall of said container has a haze of less than 5%, normalized to a thickness of 0.25 mm, and an oxygen permeability of less than 0.01 (cc.cm)/(m².atm.day)).

23. A method of producing an oxygen scavenging polymer or copolymer, comprising: reacting a dicarboxylic acid or its ester equivalent with a linear difunctional monomer having the general formula:
X—(CH₂)ₙ1'CH═CH—(CH₂)ₘ—X′
wherein X and X′ are each independently selected from the group consisting of OR and COOR, wherein R is selected from H and alkyl groups with one or more carbon atoms; and n and m are each independently 1 or more.

24. The method of claim 23, wherein said linear difunctional monomer is 2-butene-1,4-diol, and wherein said dicarboxylic acid is terephthalic acid or its ester equivalent.

25. (canceled)

26. The method of claim 24, wherein up to 75 mol %, based on total diols, of said 2-butene-1,4-diol is replaced with other diols selected from 1,4-butane diol (BDO), neopentyl glycol, 2-methyl-1,3-propanediol, cyclohexanedimethanol, or poly(alkylene oxide) glycols, and wherein up to 50 mol % of said terephthalic acid or its ester equivalent, based on total diacid, is replaced with other dicarboxylic acid or their ester equivalents selected from isophthalic acid, naphthoic acid, adipic acid, or their ester equivalents, or the anhydride of the acid.

27. (canceled)

28. The method of claim 23, including a transition metal catalyst selected from cobalt acetate, cobalt carbonate, cobalt chloride, cobalt hydroxide, cobalt naphthenate, cobalt oleate, cobalt linoleate, cobalt octoate, cobalt stearate, cobalt nitrate, cobalt phosphate, cobalt sulfate, cobalt (ethylene glycolate), and mixtures of two or more of these.

29. The method of claim 28, wherein said transition metal catalyst is added after the step of reacting.

30. The method of claim 28, wherein said transition metal catalyst is present in an amount up to 300 ppm, based on the amount of cobalt.

31. A method of making a resin, comprising: blending the reaction product made by the method of claim 23 with polyesters, polyamides or polyolefins.

32. The method of claim 31, wherein said reaction product is up to 45 wt. % of said resin.

33. (canceled)

34. (canceled)
